(19) United States
(12) Patent Application Publication
(10) Pub. No.: US 2007/0048724 A1
(43) Pub. Date: Mar. 1, 2007

(54) Extensible context-enabled software

(75) Inventors: Shane L. Griggs, Renton, WA (US); Patrick E. Plaisted, Rawson, OH (US); Andrei Slioussar, Redmond, WA (US); Jeffrey Scott Pinkston, North Bend, WA (US)

Correspondence Address: WESTMAN CHAMPLIN (MICROSOFT CORPORATION), SUITE 1400, 900 SECOND AVENUE SOUTH, MINNEAPOLIS, MN, 55402-3319, US

(73) Assignee: Microsoft Corporation, Redmond, WA (US)

(21) Appl. No.: 11/218,159

(22) Filed: Sep. 1, 2005

(51) Int. Cl. G09B 7/00

(52) U.S. Cl. 434/353

(57) ABSTRACT

Identification information that can be used to load an evaluation method and an expression that references the evaluation method are stored. Instructions are then executed to make a decision using the expression where the instructions do not include a reference to the evaluation method before execution of the instructions. The instructions load and call the evaluation method based on the stored identification information in order to resolve the expression into a value.

### BACKGROUND

In computer programs, it is common to include code that determines whether to call a method based on some condition. Often, these conditions relate to the value or attribute of an entity such that the current value of the entity is compared against one or more values. For example, a User entity could be used as a condition such that if the User entity is “Bob”, the method is executed, however if the User entity is not “Bob”, the method is not executed.

In many systems, the value of the entity that will trigger execution of the method can be set after the application has been compiled. However, the entity that is used in the condition and the condition logic itself can not be changed and are hard coded into the computer program at compile time. In some systems, such conditional execution of computer implemented methods is used to control whether particular customizations of a computer program are executed. A customization is additional programming instructions that are generally written after a base program has been written and compiled.

For example, in a business application that has a screen for managing the inventory of a business, the user can see a list of all inventory items for the business. A customization can be created for the inventory screen that will change the color of the “quantity” field on the screen to red if the quantity of the inventory item is below ten. Customizations can certainly go deeper than mere appearances; they can also enhance the core business logic of the application. For example, a second customization can be created for the screen that will automatically generate an order for a new shipment of the inventory item if the quantity falls below ten. This allows base applications to be customized for particular customers while providing a standard base program for all customers that facilitates easier upgrades and bug fixes.

The discussion above is merely provided for general background information and is not intended to be used as an aid in determining the scope of the claimed subject matter.

### SUMMARY

Identification information that can be used to load an evaluation method and an expression that references the evaluation method are stored. Instructions are then executed to make a decision using the expression where the instructions do not include a reference to the evaluation method before execution of the instructions, but the expression does reference the evaluation method. The instructions load and call the evaluation method and use the stored identification information in order to resolve the expression into a value.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a block diagram of one computing environment in which some embodiments may be practiced.

FIG. 2 is a block diagram of an alternative computing environment in which some embodiments may be practiced.

FIG. 3 is a block diagram of elements used in an extensible context-enabled software system.

FIG. 4 is a flow diagram of a method of creating and registering context classes.

FIG. 5 is a flow diagram of a method of loading context assemblies and evaluating Boolean expressions to determine whether to execute contingent methods.

### DETAILED DESCRIPTION

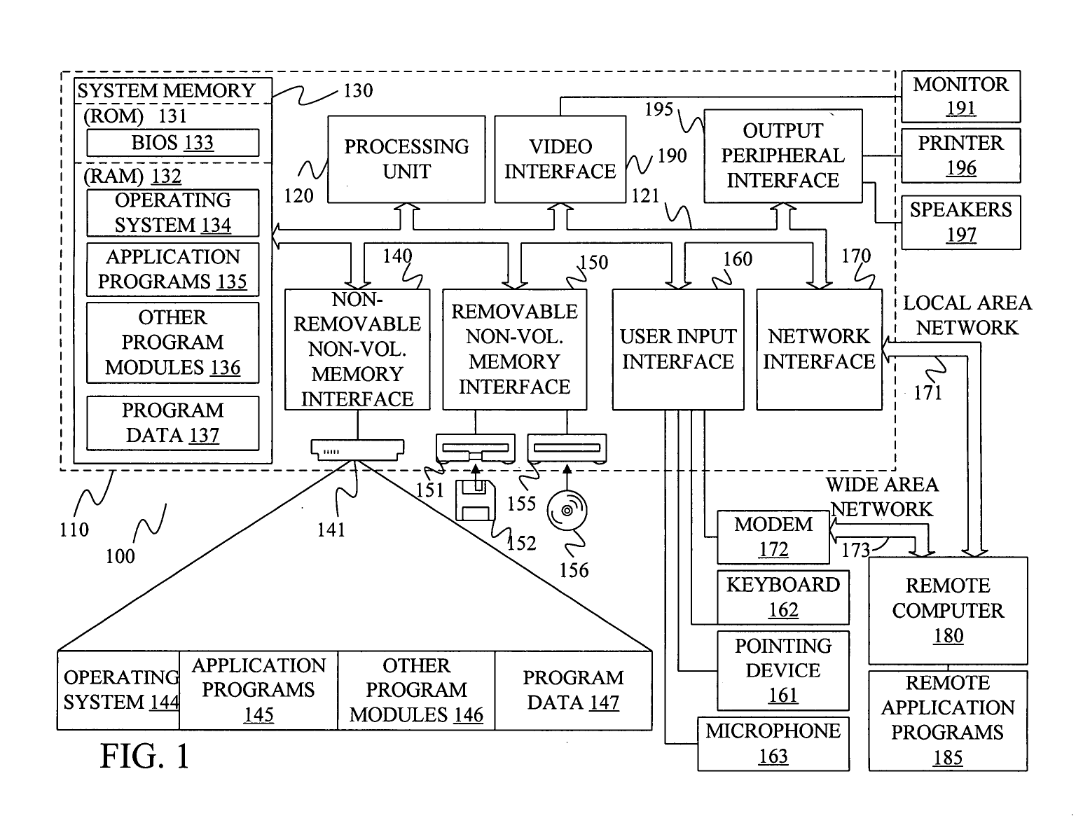

FIG. 1 illustrates an example of a suitable computing system environment 100 on which embodiments may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

Embodiments are operational with numerous other general purpose or special purpose computing system environments or configurations. Examples of well-known computing systems, environments, and/or configurations that may be suitable for use with various embodiments include, but are not limited to, personal computers, server computers, hand-held or laptop devices, multiprocessor systems, microprocessor-based systems, set top boxes, programmable consumer electronics, network PCs, minicomputers, mainframe computers, telephony systems, distributed computing environments that include any of the above systems or devices, and the like.

Embodiments may be described in the general context of computer-executable instructions, such as program modules, being executed by a computer. Generally, program modules include routines, programs, objects, components, data structures, etc. that perform particular tasks or implement particular abstract data types. Some embodiments are designed to be practiced in distributed computing environments where tasks are performed by remote processing devices that are linked through a communications network. In a distributed computing environment, program modules are located in both local and remote computer storage media including memory storage devices.

With reference to FIG. 1, an exemplary system for implementing some embodiments includes a general-purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies.

A user may enter commands and information into the computer 110 through input devices such as a keyboard 162, a microphone 163, and a pointing device 161, such as a mouse, trackball or touch pad. Other input devices (not shown) may include a joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 is operated in a networked environment using logical connections to one or more remote computers, such as a remote computer 180. The remote computer 180 may be a personal computer, a hand-held device, a server, a router, a network PC, a peer device or other common network node, and typically includes many or all of the elements described above relative to the computer 110. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on remote computer 180. It will be appreciated that the network connections shown are exemplary and other means of establishing a communications link between the computers may be used.

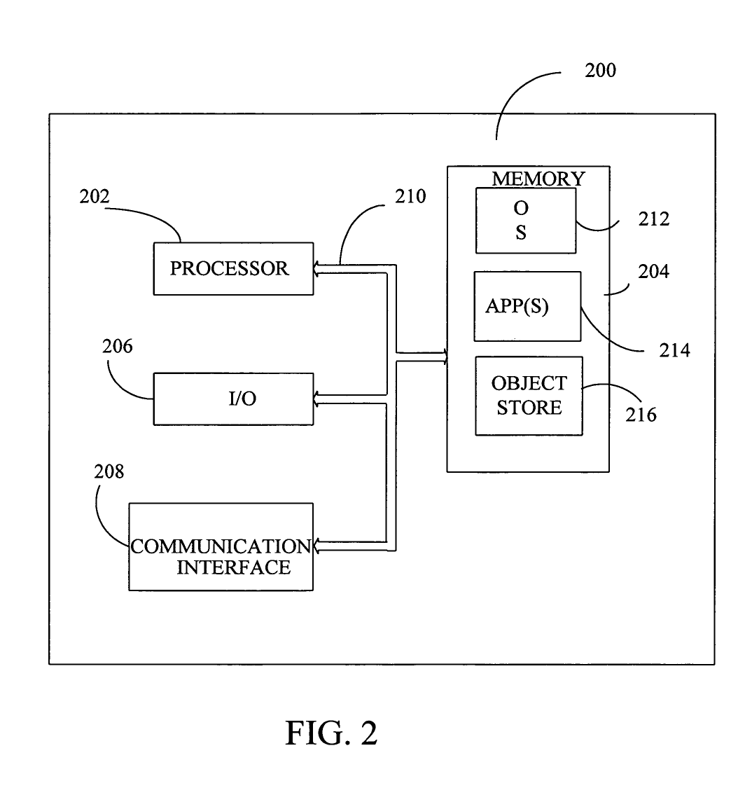

FIG. 2 is a block diagram of a mobile device 200, which is an exemplary computing environment. Mobile device 200 includes a microprocessor 202, memory 204, input/output (I/O) components 206, and a communication interface 208 for communicating with remote computers or other mobile devices. In one embodiment, the afore-mentioned components are coupled for communication with one another over a suitable bus 210.

Memory 204 is implemented as non-volatile electronic memory such as random access memory (RAM) with a battery back-up module (not shown) such that information stored in memory 204 is not lost when the general power to mobile device 200 is shut down. A portion of memory 204 is preferably allocated as addressable memory for program execution, while another portion of memory 204 is preferably used for storage, such as to simulate storage on a disk drive.

Memory 204 includes an operating system 212, application programs 214 as well as an object store 216. During operation, operating system 212 is preferably executed by processor 202 from memory 204. Operating system 212, in one preferred embodiment, is a WINDOWS® CE brand operating system commercially available from Microsoft Corporation. Operating system 212 is preferably designed for mobile devices, and implements database features that can be utilized by applications 214 through a set of exposed application programming interfaces and methods. The objects in object store 216 are maintained by applications 214 and operating system 212, at least partially in response to calls to the exposed application programming interfaces and methods.

Communication interface 208 represents numerous devices and technologies that allow mobile device 200 to send and receive information. The devices include wired and wireless modems, satellite receivers and broadcast tuners to name a few. Mobile device 200 can also be directly connected to a computer to exchange data therewith. In such cases, communication interface 208 can be an infrared transceiver or a serial or parallel communication connection, all of which are capable of transmitting streaming information.

Input/output components 206 include a variety of input devices such as a touch-sensitive screen, buttons, rollers, and a microphone as well as a variety of output devices including an audio generator, a vibrating device, and a display. The devices listed above are by way of example and need not all be present on mobile device 200. In addition, other input/output devices may be attached to or found with mobile device 200.

An extensible context system as created by the present inventors allows new methods to be added to an existing application to use in determining whether to execute contingent methods. In the description below, conditions that are evaluated to determine whether to execute a method are referred to as contexts, two or more contexts in combination with one or more operators forms an expression that can be evaluated to determine whether to call a contingent method, the methods used to evaluate the conditions are referred to as evaluation methods and the methods that are executed based on the evaluated conditions are referred to as contingent methods. Applications that use the extensible context are referred to as context consumers.

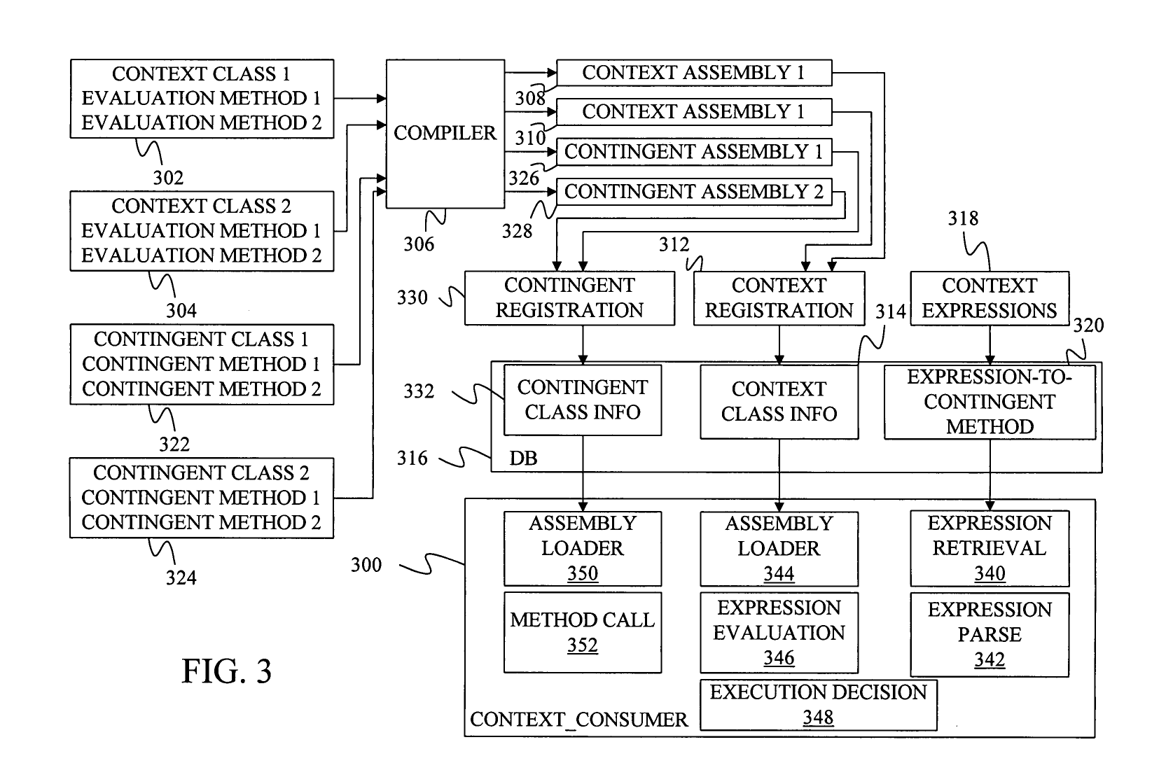

A context consumer, such as context consumer 300 of FIG. 3, is a computer program that includes computer-executable instructions that allow it to obtain conditions for executing methods after the context consumer has been compiled and to access methods that evaluate conditions that are defined in class types that were unknown at the time the context consumer was complied. Thus, the context class types that contain evaluation methods may be extended after the context consumer has been compiled and the conditions that are to be evaluated may be generated after the context consumer has been compiled.

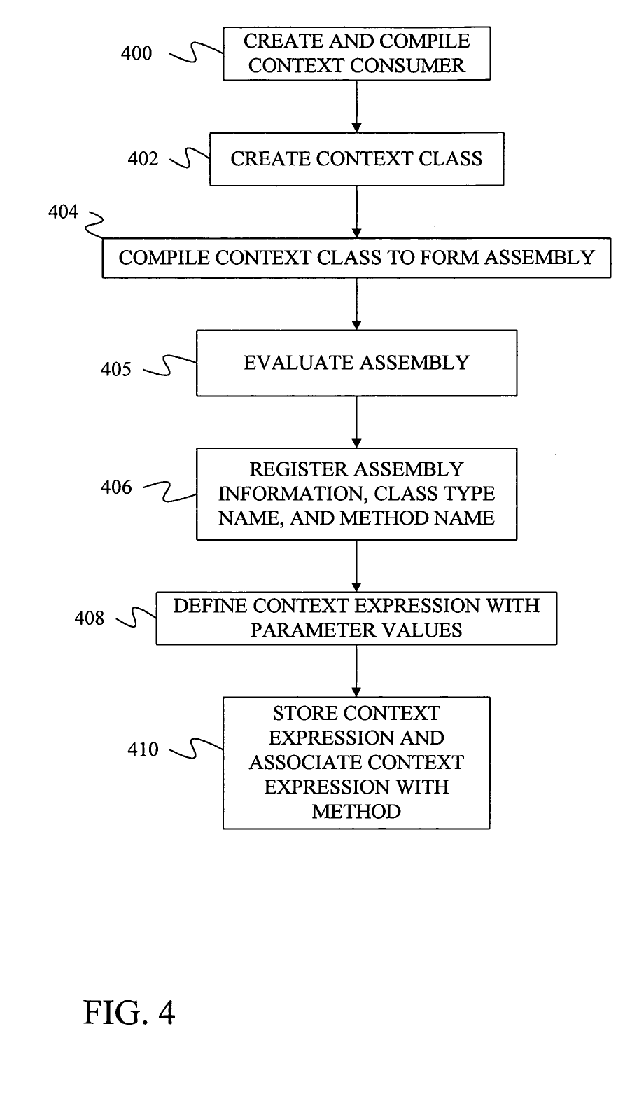

FIG. 4 provides a flow diagram of a method of creating context classes and registering them for use by a context consumer. In step 400 of FIG. 4, the context consumer is created and complied. In step 402, context classes are created such as context classes 302 and 304 of FIG. 3. Each context class defines a class type and includes one or more evaluation methods that can be used to evaluate a condition for a context.

At step 404, the context classes are compiled to form assemblies and to set assembly information that defines the identity and location of the assemblies. For example, compiler 306 of FIG. 3 compiles context class 302 to form context assembly 308 and compiler 306 compiles context class 304 to form context assembly 310. In some embodiments of the present invention, the assemblies include a manifest, which consists of metadata that describes the contents of the assembly as well as attributes of the assembly. The assembly also includes code that can be executed to perform the evaluation methods associated with each assembly. A single context class can have multiple evaluation methods and a single context assembly can have multiple context classes/types within it.

Under one embodiment of the invention, context classes must meet certain requirements so that the context consumer can load and run the methods defined within the context class using a generic algorithm. In one particular embodiment, the class must be modified by the “public” class modifier so that the class may be accessed by the external context consumer. In addition, each method must be defined by the “public” modifier. In some embodiments, the methods are further defined using a “static” modifier. In some embodiments, the methods are required to return a Boolean type. In other embodiments, any type of value may be returned.

At step 405, each assembly is validated to see if it meets the requirements of the context consumer. In some embodiments, this validation is performed by a context registration unit 312, which is provided with a path name to the assembly. For example, under some embodiments, context registration 312 will ensure that the class type of the context assembly has been designated as public and that each of the evaluation members have been designated as public. In further embodiments, context registration 312 will ensure that the evaluation methods are “static” and that they return “Boolean” type values. If the assembly does not meet the requirements of the context consumer, an error is returned and the identifying information for the assembly is not stored. While specific requirements have been discussed above, those skilled in the art will recognize that any requirements may be used that allow a generic algorithm to load and execute the evaluation methods. In particular, in other embodiments, the evaluation methods do not have to be designated as static and can be loaded and executed by instantiating the class and then calling the evaluation methods of the class instance.

At step 406, the complied assemblies are registered by storing information needed to load and run the evaluation methods. In one embodiment, this involves storing context identity information, a class type name and an evaluation method name in a context class information data source 314 of database 316.

Under some embodiments, this is also performed by context registration method 312. Under some embodiments, context registration method 312 stores the path to the assembly as part of the assembly information in context class information data source 314. In other embodiments, context registration 312 uses methods to acquire identity information from the context assembly itself and stores this identity information in context class information data source 314. This identity information can include information such as the short name of the assembly, the version, the culture info, and the public key token. In addition, context registration 312 provides the name of the class type for the context assembly as well as the name of each evaluation method in the class type.

Although the context classes are shown above as being validated before being stored, in other embodiments, the validation step occurs after the context classes have been stored.

After the context assembly has been registered, a context expression 318 is defined at step 408. The context expression includes an expression that resolves to a value and includes calls to one or more evaluation methods in the context assemblies. Each evaluation method call may include one or more parameter values that are required by the evaluation methods. In many embodiments, the context expression resolves to a Boolean type value. However, other data types may be used if the context consumer is written to use non-Boolean data in making its determination of which contingent methods to call. For example, integer values can be returned to the context consumer if the context consumer uses a Case statement to select one of multiple alternative methods to call. In some embodiments, the context expression consists of a single evaluation method call and does not include any operators. In other embodiments, the context expression includes multiple evaluation method calls that are combined by a set of operators such as Boolean operators.

In one embodiment, a separate context expression is provided for each contingent method that can be called by Context Consumer 300. In addition, context expressions for different contingent methods can call the same evaluation methods.

At step 410, the context expression is stored in an Expression-to-Contingent-Method data source 320 of database 316. Data source 320 provides an association between the context expression and the contingent method or methods that can be called based on the evaluation of the context expression.

In some embodiments, the contingent methods executed by the context consumer are known before the context consumer is compiled. Thus, the information required to call these methods is contained within the compiled context consumer. In other embodiments, the contingent methods are added after the context consumer has been compiled. For example, in customization systems in which customizations are implemented by adding contingent methods after the context consumer has been compiled, the customization methods called by the context consumer are not known when the context consumer is compiled.

Contingent methods that are executed by the context consumer and that are formed after the context consumer is compiled are defined within classes such as contingent classes 322 and 324. These contingent classes are complied by compiler 306 to form contingent assemblies 326 and 328, respectively. The contingent assemblies are registered by a contingent registration 330, which places information needed to load and run the contingent methods in a Contingent Class Information data source 332 of database 316. Under one embodiment, this information includes assembly identifier information, the class name, and the method names.

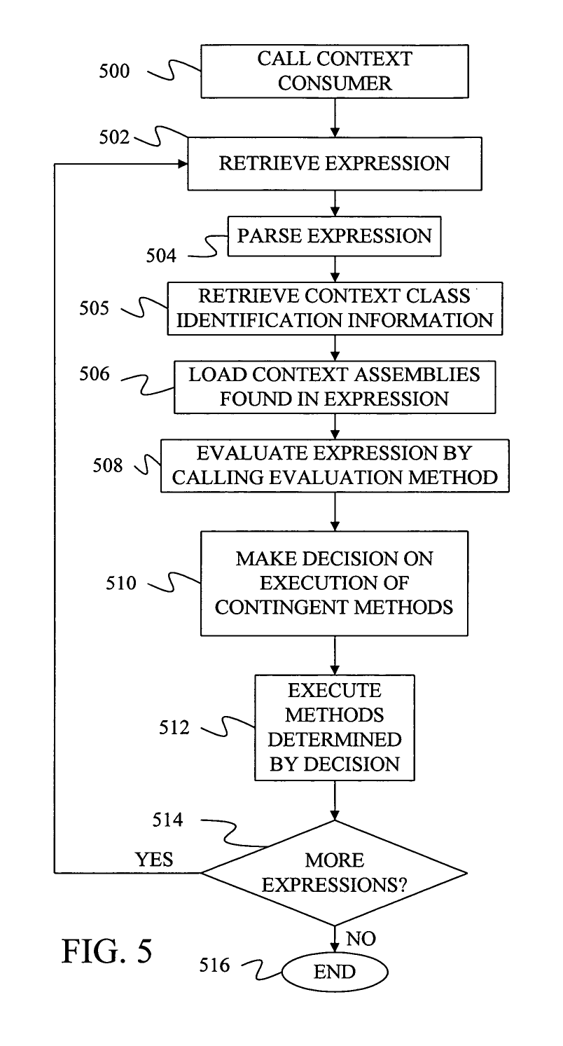

FIG. 5 provides a flow diagram of a method of determining whether contingent methods should be executed. In step 500, the context consumer is called. Under one embodiment, when context consumer 300 is called, it does not include a reference to any of the evaluation methods or context expressions. As such, it must retrieve stored information about the evaluation methods and the context expression in order to determine whether to execute the contingent methods.

At step 502, the context consumer retrieves the evaluation expression using expression retrieval 340 of FIG. 3. Expression retrieval 340 accesses Expression-to-Contingent-Method data source 320 of database 316 to retrieve an expression and one or more contingent methods associated with that expression. At step 504, context consumer 300 uses an expression parser 342 to parse the expression and identify method names in the expression. At step 505, an assembly loader 344 of context consumer 300 accesses Context Class Information data source 314 of database 316 based on the method names found in the expression and retrieves the assembly information stored in data source 314 for those methods. Assembly loader 344 then uses the assembly information to load the assembly into the current run time at step 506.

At step 508, an expression evaluator 346 evaluates the terms in the expression by calling the methods with the parameters listed in the expression. Because the context classes have been defined in a standardized way, the calls to the methods in the context classes can be made in the same way for all of the methods. The values returned by each of the context methods are combined according to the operators of the expression to form a final expression value. In many embodiments, this final expression value will be a Boolean value.

For example, in the expression “IsUser(“Mary”)↑IsRole(“Manager”)↑IsDay(“Sunday”)”, the evaluation methods IsUser, IsRole, IsDay are each called separately. The IsUser(“Mary”) term is a call to the IsUser evaluation method passing the parameter of “Mary”. The IsUser evaluation method returns true if the current user is “Mary” and return false otherwise. The IsRole(“Manager”) term is a call to the IsRole evaluation method passing the parameter of “Manager”. The IsRole method returns true if the current user has a role of Manager and false otherwise. Similarly, the term IsDay(“Sunday”), returns true if today is Sunday and false otherwise. Each of the three Boolean values are OR'd together to form a single Boolean value for the expression.

The value returned by the evaluation of the expression is then used to make a decision on the execution of the contingent methods at step 510 using execution decision block 348 of context consumer 300. When the expression evaluates to a Boolean value, the execution decision involves deciding whether or not to execute one or more methods. In more complex embodiments, the value of the evaluated expression can be used to make a selection between multiple possible methods.

If the decision is made to execute one or more methods, those contingent methods are executed at step 512. In embodiments in which the contingent methods are referenced within context consumer 300 when it is compiled, a direct call to the contingent methods can be made. For contingent methods that are not referenced in context consumer 300 at compile time, the assembly for those methods must be loaded by context consumer 300. In such embodiments, an assembly loader such as assembly loader 350 retrieves the assembly information for the assembly containing the contingent method from Contingent Class Information 332.

Once the required assemblies have been loaded or if the assemblies did not need to be loaded in order to call the contingent method, the contingent method is called by a method call 352. This method call may include the passing of parameters that were saved with the method in Expression-to-Contingent-Method data source 320.

At step 514, context consumer 300 determines if there are more expressions in Expression-to-Contingent-Method data source 320. If there are more expressions, the next expression is retrieved at step 502 together with its associated contingent method or methods. Steps 502, 504, 506, 508, 510 and 512 are repeated for the new expression and contingent methods. When there are no further expressions at step 514, the process of FIG. 5 ends at step 516.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method of making a decision using computer-executable instructions, the method comprising:
storing identification information that can be used to load an evaluation method;
storing an expression that references the evaluation method; and
executing instructions that make a decision using the expression and that do not include a reference to the evaluation method before execution of the instructions, the instructions loading and calling the evaluation method based on the stored identification information in order to resolve the expression into a value.

2. The method of claim 1 wherein storing identification information comprises compiling computer instructions for the evaluation method to form an assembly and storing identification information that identifies the assembly.

3. The method of claim 2 wherein compiling computer instructions comprises compiling a class type that includes the evaluation method.

4. The method of claim 3 wherein storing identification information further comprises storing the name of the class type.

5. The method of claim 4 wherein storing identification information further comprises storing the name of the evaluation method.

6. The method of claim 3 wherein compiling the class type comprises compiling a class type that is declared as public.

7. The method of claim 6 wherein compiling the class type comprises compiling a class type in which the evaluation method is declared as public.

8. The method of claim 6 wherein compiling the class type comprises compiling a class type in which the evaluation method is declared as static.

9. The method of claim 1 wherein the expression references the evaluation method by calling the evaluation method with at least one parameter value.

10. The method of claim 1 wherein the instructions require that the resolved value of the expression be of a particular type.

11. The method of claim 10 wherein the particular type is a Boolean type.

12. The method of claim 1 wherein the decision made by the instructions comprises a decision to execute a contingent method.

13. The method of claim 12 further comprising associating the contingent method with the expression.

14. The method of claim 13 wherein storing the expression comprises storing an association to the contingent method with the expression.

15. The method of claim 1 wherein storing identification information that can be used to load an evaluation method comprises verifying that the evaluation method satisfies at least one requirement.

16. A computer-readable medium having computer-executable instructions for performing steps comprising:
receiving an expression and receiving information to load computer-executable instructions that implement a method called in the expression;
loading computer-executable instructions that implement the method based on the information; and
resolving the expression to produce a value in part by calling the method.

17. The computer-readable medium of claim 16 wherein the expression is associated with a contingent method and wherein further steps comprise using the value resolved from the expression to determine whether to call the contingent method.

18. The computer-readable medium of claim 16 wherein receiving the information for the method comprises validating the method to ensure it satisfies certain requirements.

19. A method comprising:
validating an assembly for a context type to determine if the context type meets requirements associated with a context consumer method;
storing identification information for the assembly if the context type meets the requirements;
storing an expression that calls a method in the context type;
executing the context consumer method to retrieve the stored expression, to retrieve the identification information based on the retrieved expression, to load the assembly based on the identification information, and to call the method in the context type.

20. The method of claim 19 wherein the expression is associated with a contingent method and wherein executing the context consumer method further comprises determining a value for the expression based on the call to the method in the context type and using the value for the expression to determine whether to call the contingent method.
